(19) United States
(12) Patent Application Publication
(10) Pub. No.: US 2008/0195576 A1
(43) Pub. Date: Aug. 14, 2008

(54) Method, and Computer Based-System and Virtual Asset Register

(75) Inventors: Gorm Sande, Slependen (NO); Jan Bugge, Sandvika (NO); Lars Gundersen, Oslo (NO); Svein Vatland, Sandefjord (NO); Tormod Lund, Oslo (NO); Erik Svensson, Zurich (CH); Danny Julian, Willow Spring, NC (US); Claus Vetter, Buchs/Ag (CH); Thomas Werner, Baden (CH)

Correspondence Address: VENABLE LLP, P.O. BOX 34385, WASHINGTON, DC, 20043-9998, US

(73) Assignee: ABB Technology Ltd., Zurich (CH)

(21) Appl. No.: 10/590,028

(22) PCT Filed: Feb. 18, 2005
(86) PCT No.: PCT/SE05/00222

§ 371 Date: Oct. 30, 2007

Related U.S. Application Data
(60) Provisional application No. 60/545,924, filed on Feb. 20, 2004.

(51) Int. Cl. G06F 7/06; G06F 12/00; G06F 17/30

(52) U.S. Cl. 707/2; 707/204; 707/103 Y; 707/E17.001; 707/E17.01; 707/E17.125

(57) ABSTRACT

A method and computer-based system for retrieving, accessing and storing data otherwise stored in a plurality of IT systems arranged for operating a part of one or more electrical power networks. The method and computer-based system provide integration of otherwise separate systems such as GIS, SCADA, ERP and/or CMMS. The integration includes an XML/CIM layer for data exchange and a virtual asset register containing references to objects representing assets in the power networks. A human-machine interface and a computer program for carrying out the method.

### TECHNICAL FIELD

The present invention is concerned with a method and computer-based system for controlling, monitoring and/or maintaining equipment in an electrical power distribution system. In particular it is concerned with a database consistency method and computer-based system that enables consistent retrieval, synchronisation and storage of data between a plurality of databases containing information and data relative to operating an electrical power network.

### TECHNICAL BACKGROUND

Electrical power distribution network systems for industrial and residential power users typically comprise many and various types of distribution equipment located over a large geographic area. Most utilities operating a geographically distributed asset such as an electrical power network need a suit of IT support systems to manage the operation and maintenance of the assets. Today there is no common way of information integration between these systems which makes information retrieval difficult when more than one system is involved. For example, a power transformer device must be known in several systems. The customer information system has knowledge what customers are connected to the transformer. The Network Information system (NIS or GIS) has information about the geographical location of the transformer. The ERP system (Enterprise Resource Planning) has the maintenance history of the transformer and the SCADA system (Supervisory Control and Data Acquisition) knows the actual performance measurements, temperature, voltages and so on of the transformer.

A successful integration of a GIS (Geographical Information System) system, preferably with other systems such as a real time SCADA system with an ERP system would make power network information available to the ERP system. U.S. Pat. No. 6,564,201 B1, entitled Expert designer system virtual plug-in interface; describes virtual plug-in interface for an expert designer system for use with one or more database system types operates. These systems include a geographic information system (GIS) and a work management system (WMS). It is described that the virtual GIS plug-in interface interacts with the GIS such that the expert designer system core functions independently of the type of GIS database system. The document discloses use of object-oriented programming architectures to make a virtual interface for GIS and/or WMS systems which is independent of specific database type or manufacturer and simplifies the task of designing GIS databases.

Integration of ERP and GIS database systems would facilitate automatic creation of work orders from the ERP system for condition-based maintenance dependent on more automatic or manually controlled outputs from, for example, a SCADA system. For example maintenance could be scheduled on a basis of accumulated short circuit limits for a given breaker. Another example would be automatic generation of work orders for inspecting a protection device used with low frequency a distribution or a feeder line. It would also be possible to validate that future scheduled maintenance activities is permissible with respect to other maintenance activities, switching status, available power production resources, transmission capabilities and forecasted consumption and so on.

One complication to be dealt with is that changes in the power grid assets would need to be reflected in the IT systems. In addition, several types of power devices need to be modelled in more than one IT system. For example, a power transformer device must be known in several systems an example previously mentioned. For example, the customer information system (CIS) has knowledge of which customers are connected to the transformer, the NIS system has information about the geographical location of the transformer, the ERP system has the maintenance history of the transformer and the SCADA system has the real time and stored measurements taken at the transformer.

Within the power industry and network management industry a common approach to document exchange and conversion, CIM, Common Information Model, has been developed around the use of XML-based formats. More information on current practices and method for use of CIM/XML (Common Information Model/eXtensible Markup Language) for data exchange within the electrical power industry may be obtained from North American Electricity Reliability Council (NERC), Federal Energy Regulatory Commission (FERC). The CIM/XML standards greatly facilitate the exchange and automatic conversion of documents produced by one supplier of a part of the network or an equipment for the network so that a second supplier can receive, handle and re-use the technical data from the original documents without manual intervention, editing or re-inputting.

However there is a series of difficult challenges to be overcome to achieve the kind of integration desired for the separate IT systems described. A demand facing utility network owners and operators is to extract more value from the existing assets in a network utility, in terms of higher output without causing increased maintenance work, breakdowns or equipment loss. Another demand is to be able to integrate IT systems so as to make information accessible to all users who have an interest in the network. Manual linking and connections have been made in the past to exchange data between different IT systems, and to reconcile data for consistency. However this has been done manually or on a batch basis and has not been practically implemented on a real-time basis. The task of integrating separate IT systems is complicated. In particular, there is a difficult technical problem of sharing data between different databases and at the same time achieving and maintaining data consistency between multiple IT systems. In addition, the real-time nature of power network operation demands of that data retrieval and/or communication can work at high speeds in a network utility and in an automated and effective way.

### SUMMARY OF THE INVENTION

The present invention aims to solve one or more of the above problems.

According to one aspect of the invention, the object is achieved by the initially defined method.

According to another aspect of the invention, the aims are achieved by a software architecture including a consistency and mapping layer based on a structured text standard.

According to another aspect of the invention, the aims are achieved by register of power network held by a computer-based system.

According to another aspect of the invention, the aims are achieved by a computer-based system.

A major advantage of the present invention is that integration is carried out in such a way that data across the different systems is kept consistent. In addition, the invention provides as well a new and better platform with which to support asset management applications.

The system integration achieved by the invention provides interface and access advantages for users of power network systems such as:

a series of User Interface navigation displays used and operated by users with standard object-oriented navigation, selection, input and display methods. The displays give timely access to all relevant information, and from all integrated IT systems. The integrated systems comprise data and data representations that are context sensitive, and provide simple and unified ways to navigate between different functional views, technical views or contextual views of the same process equipment, device, installation or other network asset. In addition the invention provides advantageously for one consistent asset representation using the Virtual Asset Register (VAR), with single data entry, automatic synchronization, data exchange between applications and both mapping to CIM/XML model as well as import & export to CIM/XML. The integrated systems do not require any other special provisions and may, for example, use applications that can work on one or more generic CIM models. The all-important consistency checks may take place in the background, and be thus not visible or apparent to a user.

The integrated systems provided by the invention have the advantage of providing means for:
reduced data maintenance cost for the network,
optimised service life of equipment,
increased quality of asset data, and
improved decision support.

As much of the invention is implemented in software and may be implemented by means of novel software architectures the necessary time and capital cost of including the invention in both new installations and existing installations is relatively low and therefore also very advantageous for that reason.

According to another aspect of the invention, the aims are achieved by (one or more) a computer program directly loadable into the internal memory of a computer or processor, comprising software code portions for performing the steps of the method(s) according to the invention, when said program is run on a computer or processor. The computer program is provided either on a computer readable medium or through a network, a high-speed private network, such as a local area network or a wide area network including the Internet.

According to still another aspect of the invention, the objects are achieved by a computer-readable medium having at least one program recorded thereon, where the program is to make a computer or processor perform the steps of the method according to the invention, when said program is run on a computer or processor.

### BRIEF DESCRIPTION OF THE DRAWINGS

Embodiments of the invention will now be described, by way of example only, with particular reference to the accompanying drawings in the attached presentation file which:

FIG. 1 shows a schematic block diagram of different IT systems and databases integrated by a CIM/XML layer and an HMI layer according to an embodiment of the invention.

FIG. 2 shows a schematic block diagram of integrated and different IT systems and databases in which the CIM/XML layer comprises a Virtual Asset Register and a data exchange middleware and supports an asset optimization application according to another embodiment of the invention.

FIG. 3 is a table or matrix over functions, purposes and implementations for data exchange and other applications in a power network according to an embodiment of the invention.

FIG. 4 shows a schematic block diagram of both predictable and condition based maintenance in provided by data exchange and other applications such as a CMMS (Computerised maintenance management system) in a power network.

FIGS. 5, 6, 7 show stages in a method for handling alarms and faults using an HMI to interface both a SCADA system and a maintenance or CMMS application in connection with data exchange and other applications in a power network according to another embodiment of the invention.

FIGS. 8, 9 show stages of a method for handling alarms and faults using an HMI to interface objects in both a SCADA system and a maintenance or CMMS application to GIS system data for the same object(s) in connection with data exchange and other applications in a power network according to another embodiment of the invention.

FIGS. 10, 11 show representations of steps in alarm handling using an HMI to interface objects in SCADA, maintenance or CMMS, GIS wherein information about an object, a breaker, from a maintenance or technical information database is simultaneously accessed, according to another embodiment of the invention.

FIG. 12 is a schematic block diagram of different local IT systems and databases integrated by a CIM/XML layer using XLST transforms to map global objects to local objects consistently according to an embodiment of the invention.

FIG. 13 is a schematic block diagram of different IT systems and databases integrated by a CIM/XML layer using adapters to map the XML, attribute changes and object according to an embodiment of the invention.

FIGS. 14, 15, 16 show schematic overviews for data consistency between different local IT systems and databases SCAD, ERP and GIS integrated by a CIM/XML layer, and with respect to mapping and attribute conflicts.

FIG. 17 shows a schematic overview including data from a GIS system in respect of a new object added to the network;

FIG. 18 shows schematically how that same new object may also be recognized in the SCADA and ERP systems, according to an embodiment of the invention; and

FIG. 19 shows a flowchart for a method according to an embodiment of the invention.

### DETAILED DESCRIPTION OF THE EMBODIMENTS

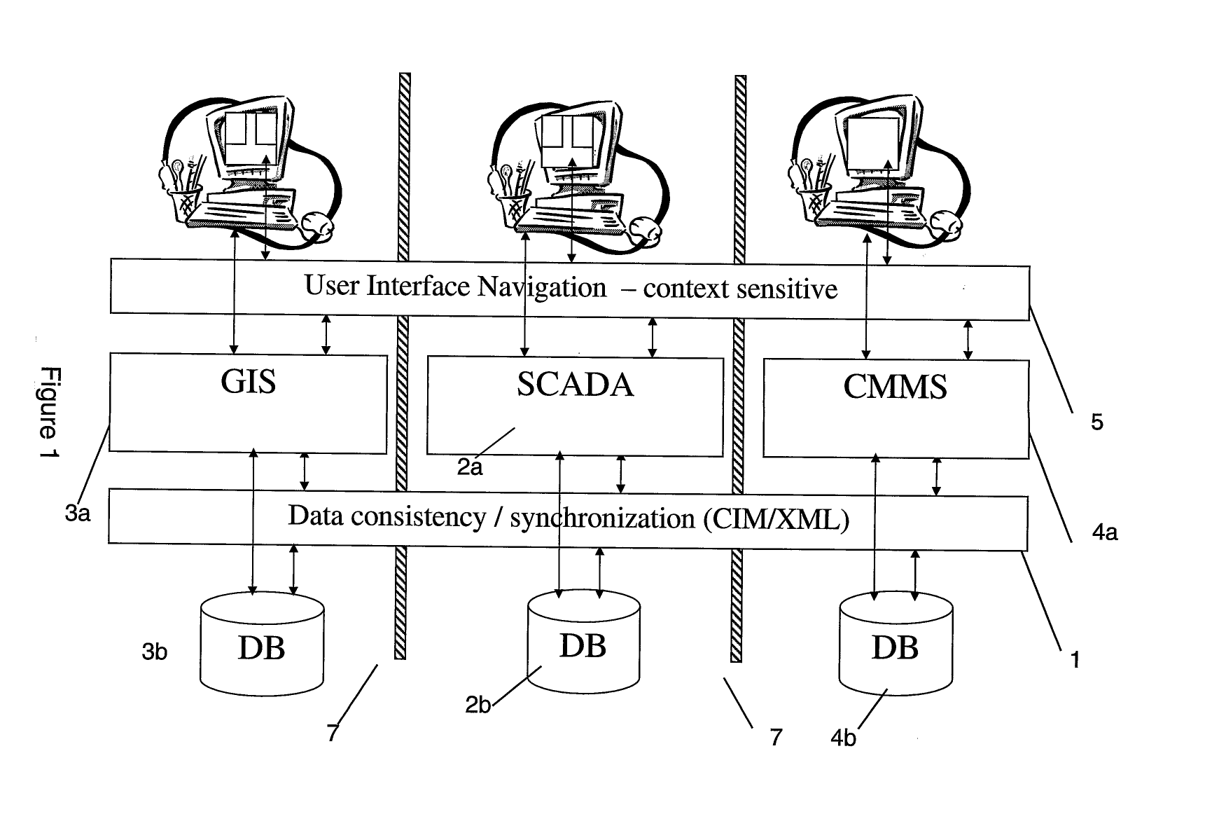

FIG. 1 shows schematically three separate systems which are each operating in a part of a power network. It shows a SCADA (Supervisory Control and Data Acquisition) system 2a, with a database 2b; a GIS (Geographical Information System) system 3a with a database 2b, and a CMMS (computerised maintenance management system) 4a and database 4b. A wall 7 is shown symbolically separating each system. A first layer 1 is shown bridging the otherwise separate IT systems. Layer 1 is a CIM/XML layer for data consistency and/or synchronisation. A user interface navigation layer 5 which, as will be described in more detail later, also comprises one or more HMIs and is also shown bridging the otherwise separate systems.

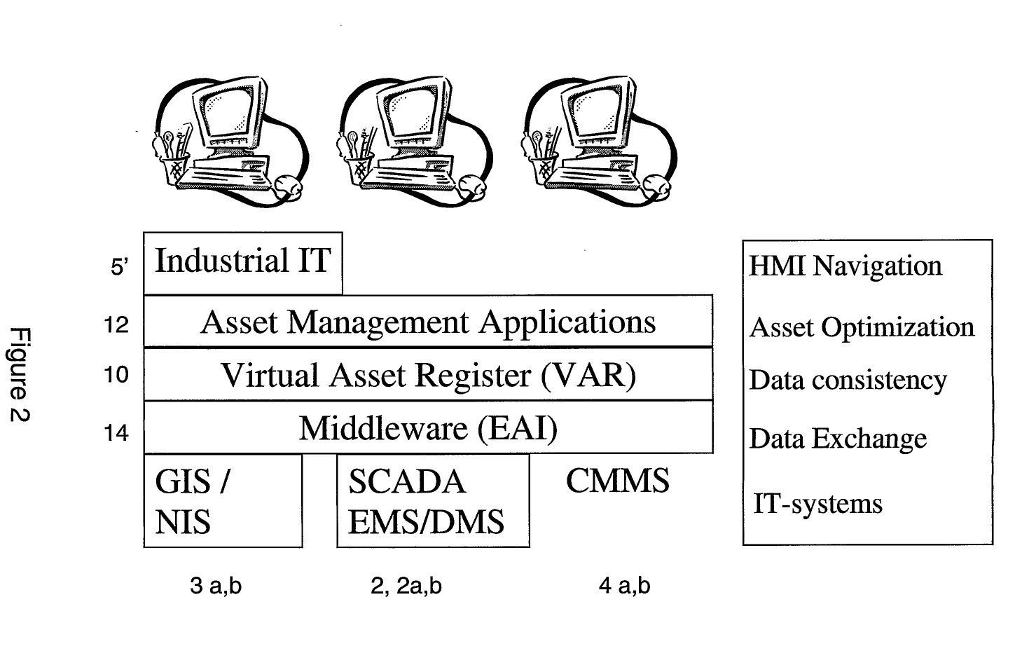

FIG. 2 shows schematically an architecture in more detail. It shows separate IT systems for operations of the power network such as SCADA, EMS (Energy Management System) 2a and DMS (Distribution Management System) 2b; a maintenance system such as a CMMS 4a, b; and GIS or NIS systems 3,a, b. The IT systems are connected via a middleware EAI (Engineering Application Integration) layer 14 and a Virtual Asset Register (VAR) 10 to a user interface navigation layer 5′ that comprises one or more HMIs. Also included in the architecture are one or more applications for asset management 12.

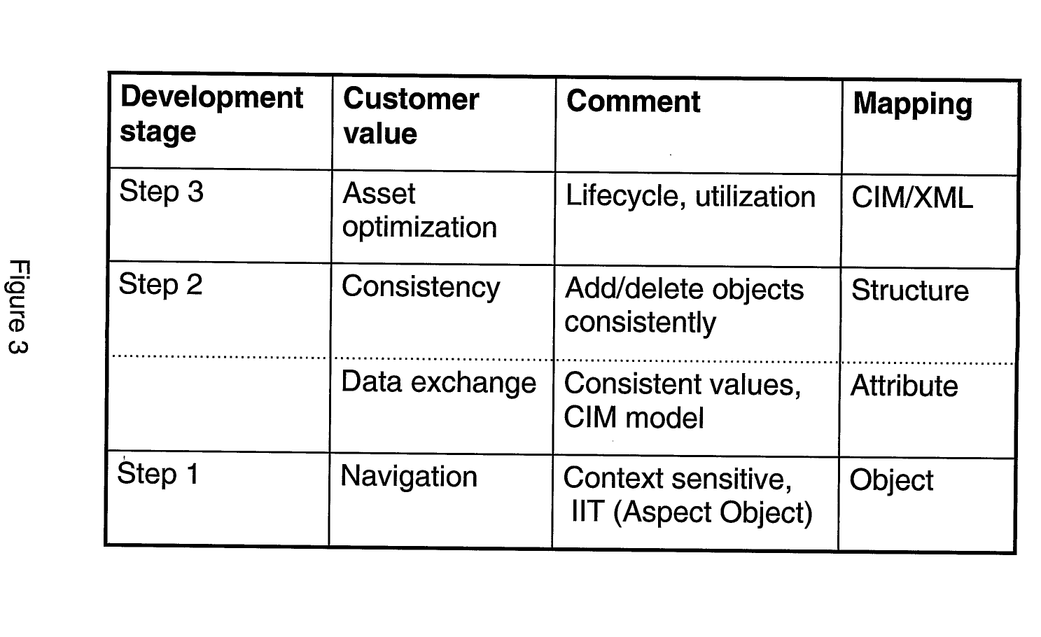

FIG. 3 shows in a matrix form various network operation functionalities, under the heading Customer value, with a comment or expanded explanation under the heading Comment, and possible implementations under the heading Mapping. It shows in Step 1 that the Navigation functions of the present invention are context sensitive, depending on which context i.e. which system is currently activated by the user, which is achieved and implemented by object and object-oriented architecture to enable linking between the representations of the same object in all systems. Step 2 shows that Consistency means that objects may be added and or deleted in a consistent way across all systems, implemented by a grouping function, a hierarchical parent-child type of grouping model using object-oriented references also referred to as structures; and that data exchange is carried out consistently and based on a CIM model and implemented by means of checking attributes of the objects in the separate IT systems for consistency with stored values for such attributes.

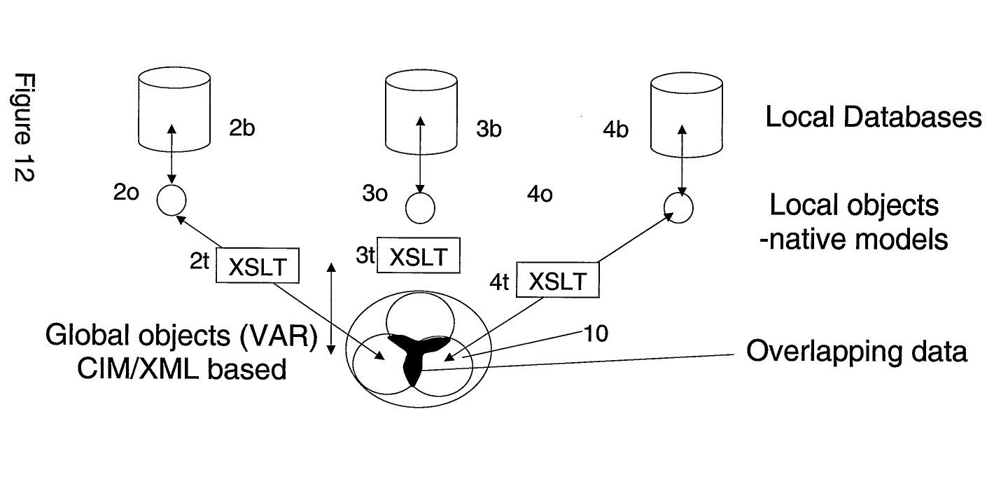

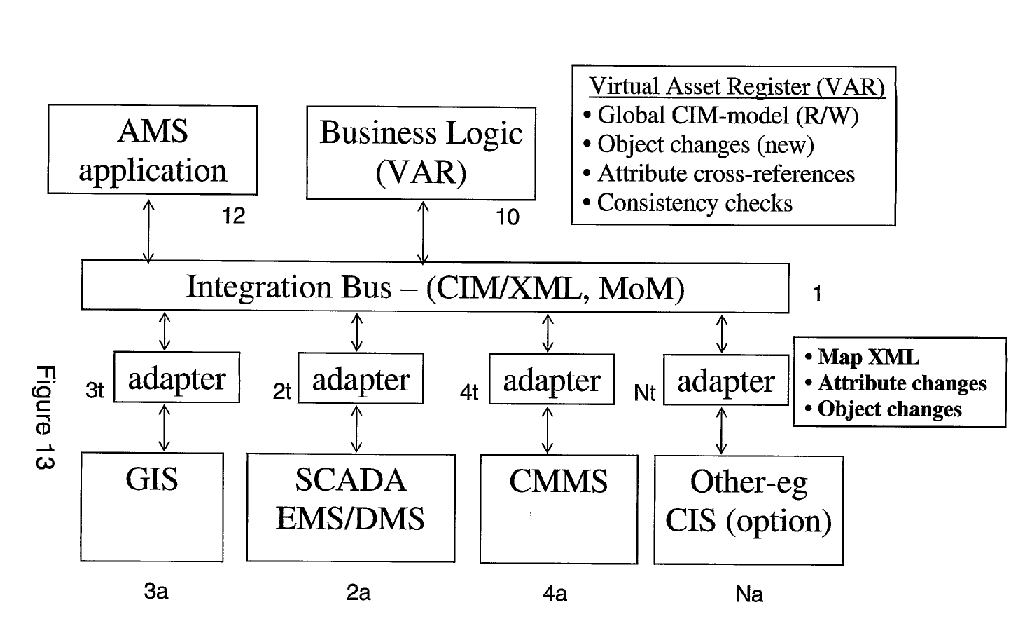

Step 3, Asset Optimization is primarily concerned with optimising the service life of equipment in the network, for example by means of an optimised balance between condition-based maintenance and/or predictable maintenance and/or planned maintenance. This may be carried out by the use of a CIM/XML model and mapping between systems, eg mapping from a given fault object reported by a SCADA system to the same given object held in a maintenance system such as a CMMS system, which mapping is carried out by means of the virtual asset register (VAR) as described in more detail below with reference to FIGS. 12, 13.

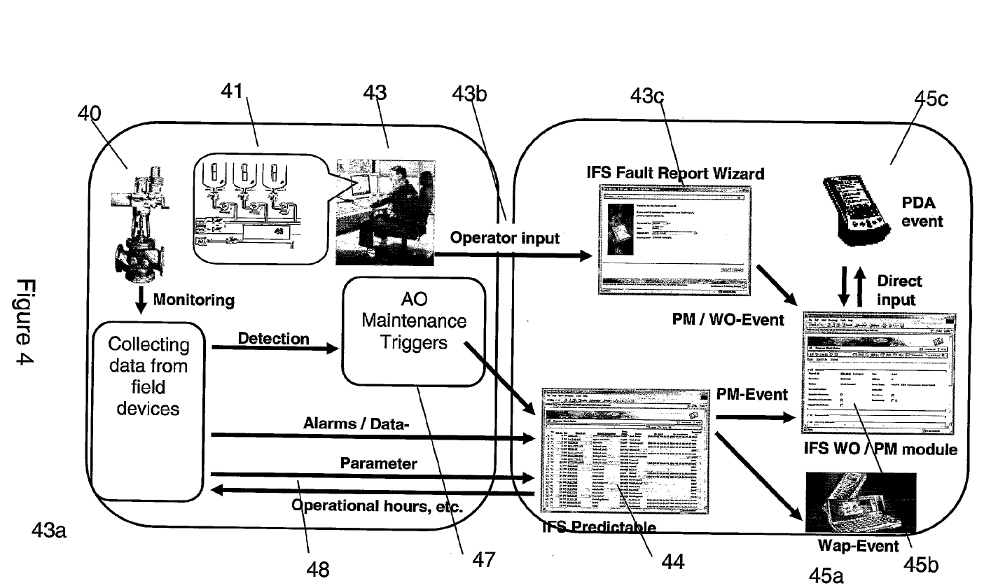

FIG. 4 shows an optimised example for handling maintenance faults according to an embodiment of the invention. The figure shows an equipment 40 monitored by a SCADA system, and modeled on an HMI of a operation system 41. The figure shows that an operator 43 may provide operator input through an application 43c of the HMI which may be communicated to a Predictable Maintenance (PM) or Work Order (WO) application 45b of a PM or WO system. The figure also shows that the SCADA system collects data from field devices 43a, such as the above equipment 40, and provides alarms and/or data events, parameters etc 48 to a PM system 44. Automation equipment can trigger work orders based on real time information from the equipment itself, for example operational hours, fieldbus information, maintenance triggers or software agent-type maintenance triggers. It can further be seen that as well as data collection from devices, direct input 43b from a control centre operator and/or direct input 45c from an engineer in the field with a portable device may be received by the PM system and be then available to the other systems. The Work Order (WO) system may be a part of or module for a maintenance system, or it may be a part of an ERP (Enterprise Resource Planning) system. Alternatively direct input 43b may be generated by an automatic, computerised process instead of or as well as a human operator.

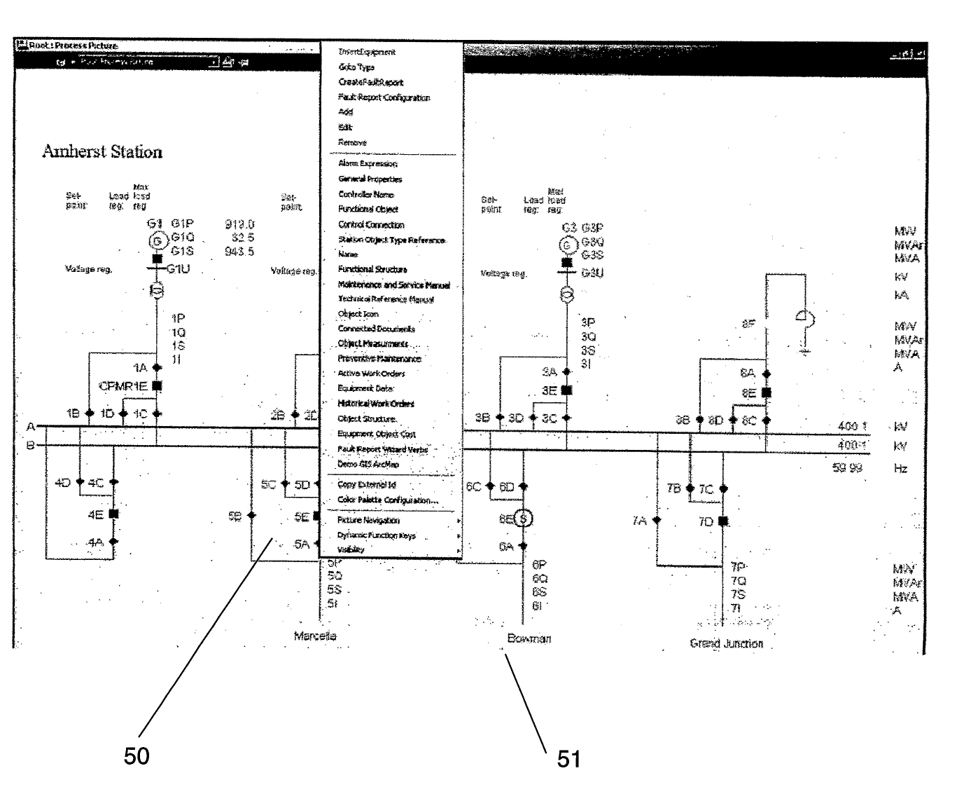

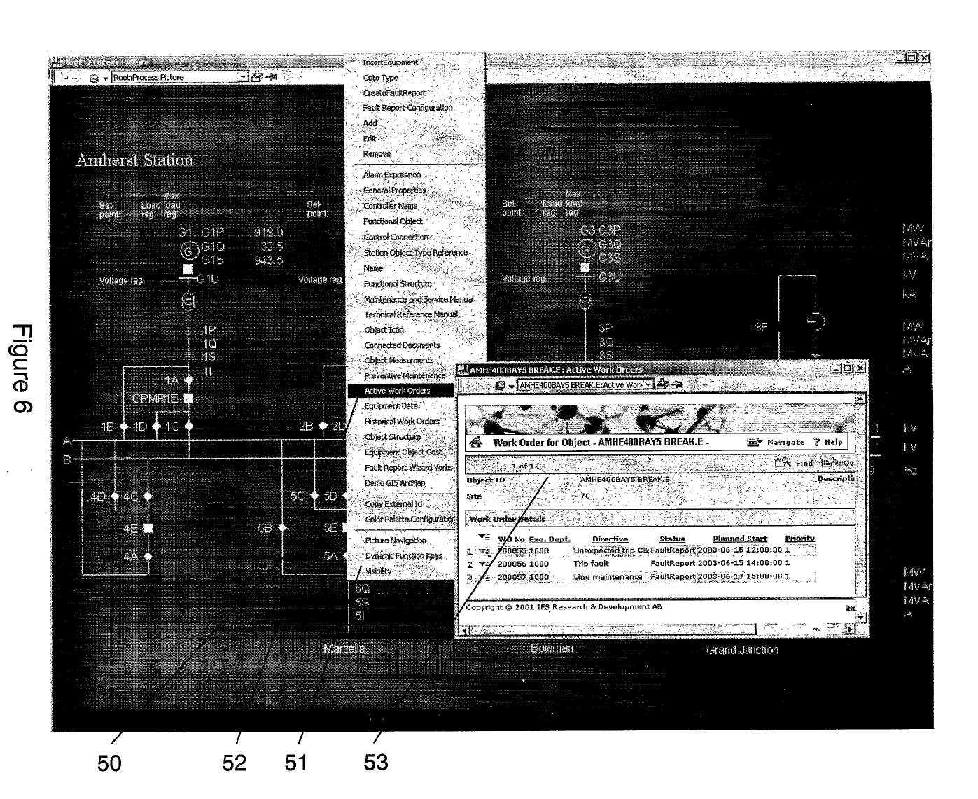

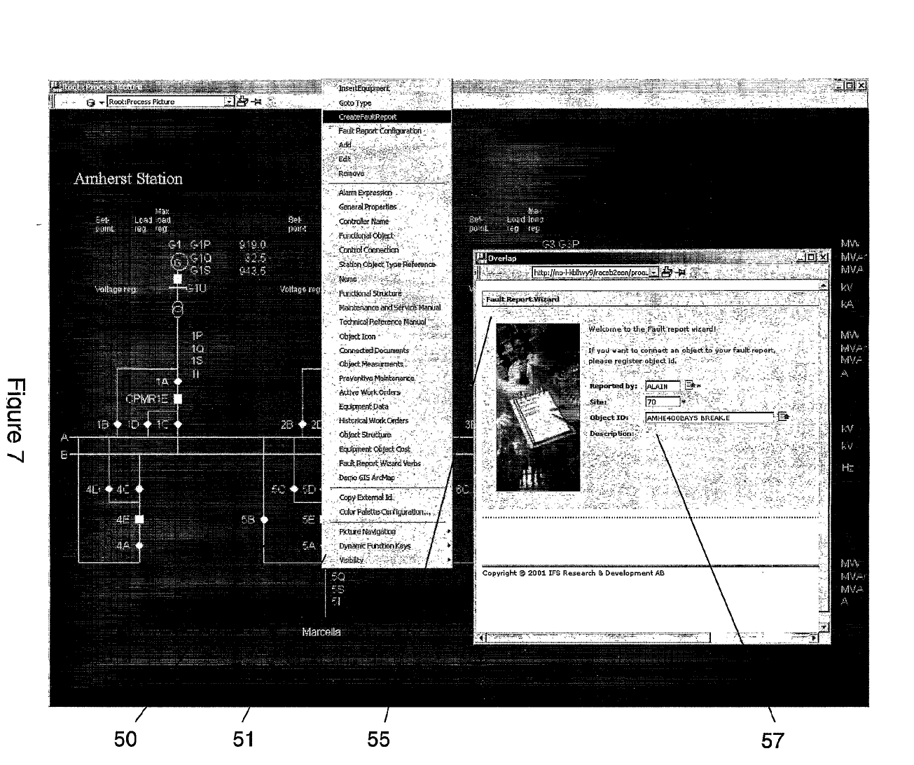

FIG. 5 shows in more detailed description a stage of handling a fault in an equipment similar to that fault described in relation to FIG. 4. A fault is reported by the SCADA system, in Bay 5, 50 and the faulty object may be selected on a screen of an HMI of a Navigation System accessing the SCADA system data. The user is then presented with options, in this example by means of a drop-down window 51. FIG. 6 shows how the user may select Active Work Orders 52 to check the current maintenance situation for this object, a breaker. An interface element, in this case the window 51, accessing Active Work Order status 53 retrieved from a maintenance system such as a CMMS (Computer managed maintenance system), shows the faulty equipment, the object, and any active work orders for it. FIG. 7 shows how, using a fault reporting element 55 of the HMI interface, the user may file a fault report which may become the basis of a new work order. This also corresponds to the fault report 43c of FIG. 4.

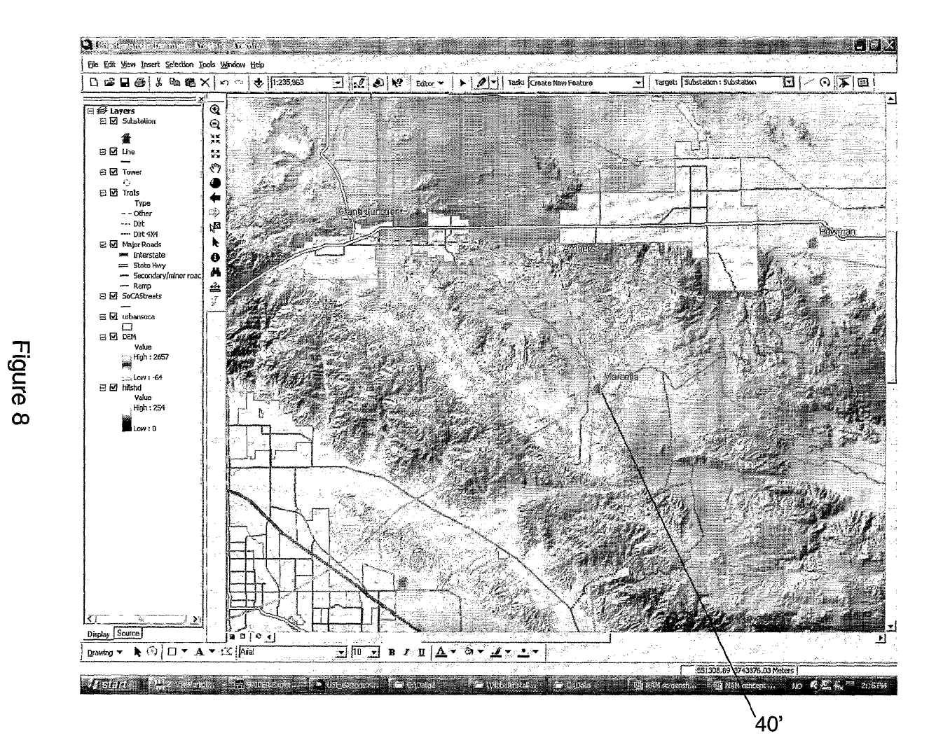

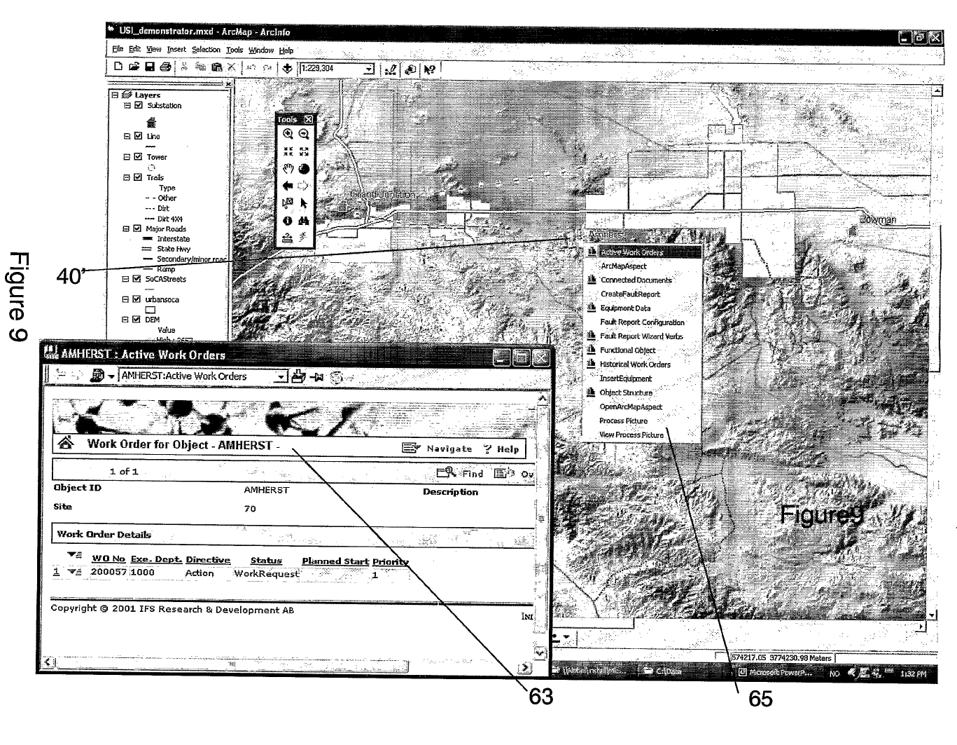

FIG. 8 presents information about the same selected faulty object 40′, the breaker, from the Geographical Information System (GIS), giving an overview of the geographical location of the breaker. FIG. 9 presents a view of the HMI with which a user may access a work order, in this case the new work order 63 for the breaker by means of options in a drop down window operable from the selected screen object from the location display provided by GIS information.

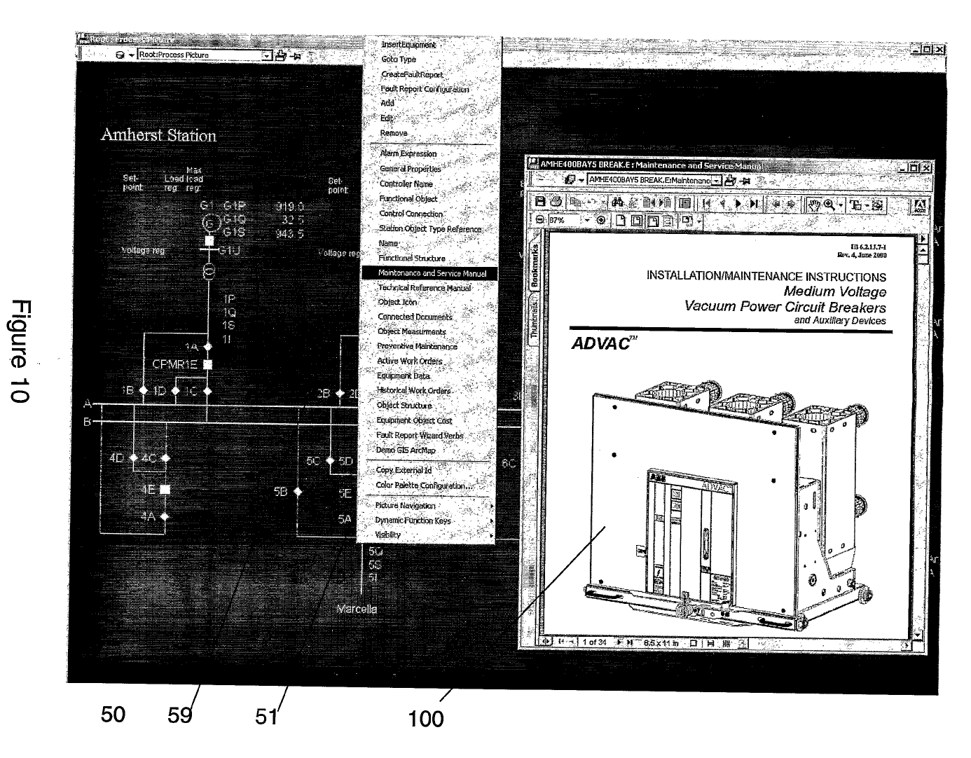

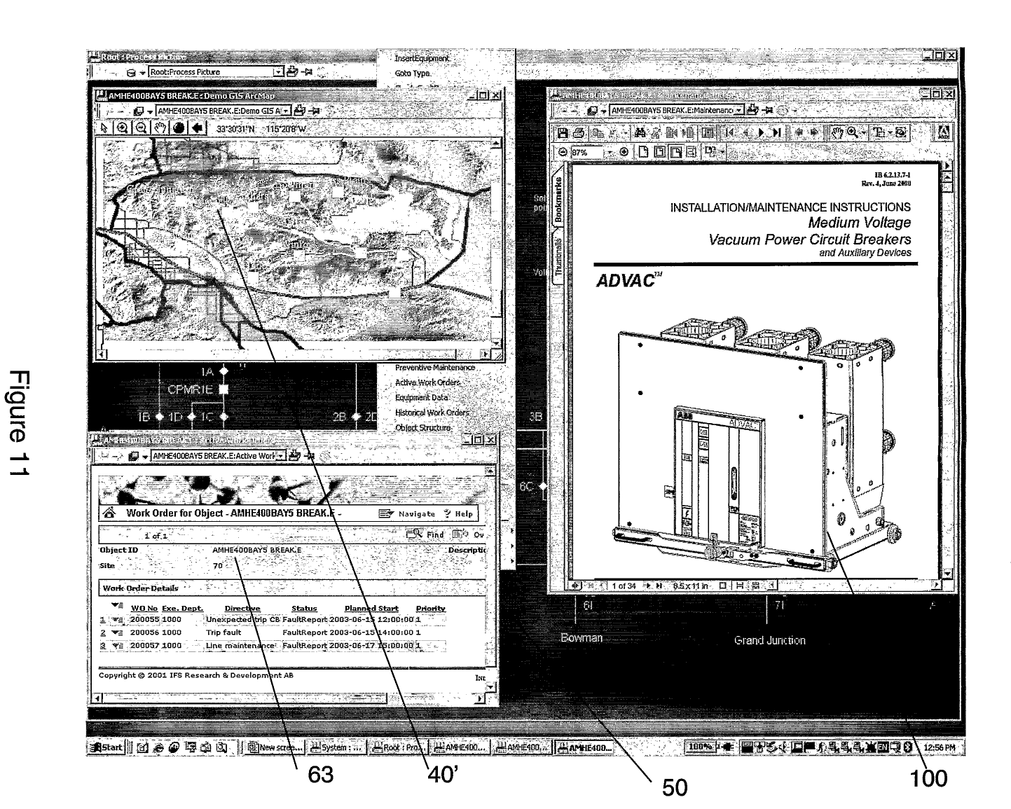

FIG. 10 is similar to FIG. 5, showing the faulty equipment with options displayed, with in this case, an option to access 59 the Maintenance and Service Manual for the selected object, the breaker, which produces product documentation 100. FIG. 11 shows how the HMI in the Navigation Interface System integrates information and access for the same selected object so that the SCADA system information 50, the GIS system information 40′, the CMMS work order information 63 and the CMMS Technical Manual information 100 may presented for a user to see, access and/or manipulate at the same time. In addition, distance and/or route to a site may be seen simultaneously from the GIS information which facilitates determining which repair crew should be dispatched and what extra factors concerned with distance to site, time to site and/or details of site topology need to be considered. The display shown by FIG. 11 comprises then information from separate IT systems, SCADA, GIS, CMMS, that is to say, data and/or information accessed in the separate IT systems and retrieved at the same time and displayed together by the computer-based system for the user. The user has full access to data held by each of the IT systems by provided by the invention, which data is maintained in a fully consistent state by the consistency mechanisms of the invention.

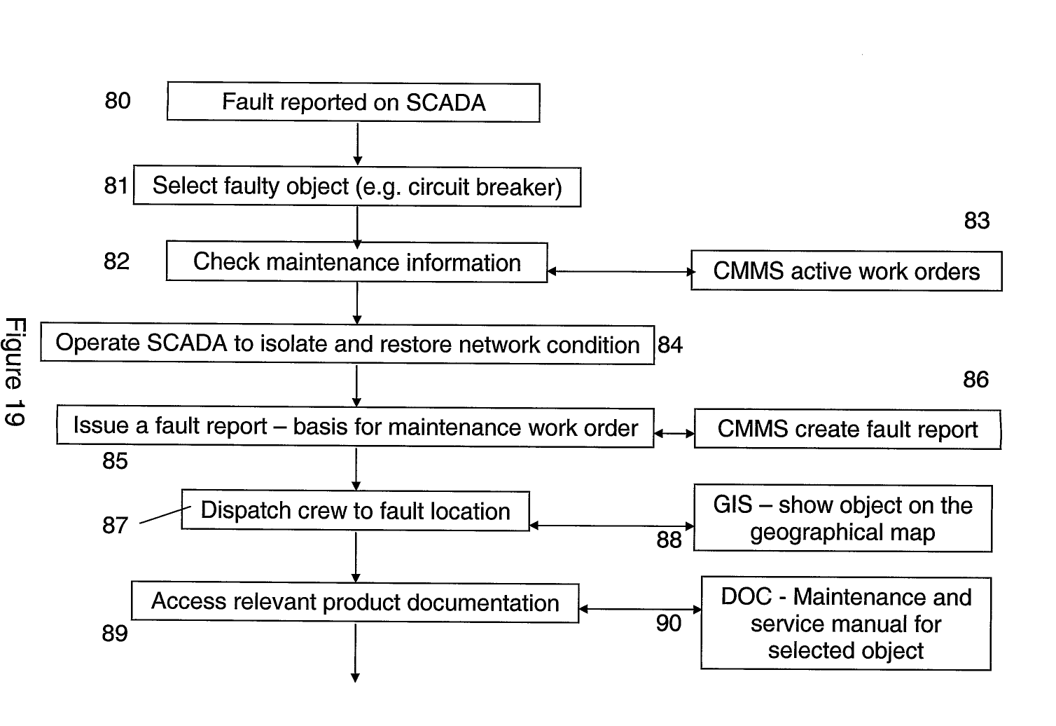

FIG. 19 shows the above method in the form of a flowchart. Some of the steps of the method are carried out by means of computer programs. The steps of the method in this exemplary example begin with a signal from one particular IT system of the network, in this case and not exclusively, beginning at 80 with a SCADA report, in this case and not exclusively in the practice of the invention, a fault report. At 81 the faulty object is selected on a display by a user, operator. This step may alternatively be carried out by a process running in a computer, that, in effect, executes a process that has the equivalent effect of selecting the faulty object. At 82 a user checks maintenance information, for example to see what work orders are active in a CMMS system. The SCADA system is operated 84 to isolate an equipment and to restore the network to an operating condition; this may be done by an operator, a process in a computer, or by a combination. This means then that the SCADA system is operated, ie control signals are generated by the SCADA system so as to switch lines and/or equipment on or off, in this case, for the purpose of isolating an equipment or part of a line. At 85 a fault report may be created by the operator in the CMMS system 86, or semi-automatically, or automatically by CMMS. On the basis of the information provided in the computer-based system from SCADA, CMMS and GIS, an operator or a pre-programmed process may dispatch a work crew 87 to a fault location, such that the crew as well as other users of the computer-based system has access to the GIS geographical information, map, to find the best route to the location. At the same time, product documentation is retrieved 89 and accessed 90 so that detailed maintenance information for the equipment of interest is simultaneously available throughout the computer-based system for any validly logged on user.

FIG. 12 shows in a schematic block diagram an overview of the global-local relationships, and that part of how data consistency is maintained. FIG. 12 shows local databases, accessible in relation to local objects, linked to a set of global objects comprised in a virtual asset register (VAR). The figure shows a local SCADA database 2b, a GIS database 3b and a CMMS database 4b. It also shows a VAR 10 linked by adapters or in this case transform means XLST 2t, 3t, 4t to a local object, 2o, 3o, 4o, and thus by means of those two functional elements to each of the three local databases 2b, 3b, 4b. Global objects which are based on a CIM/XML model are maintained in the VAR 10 as links to objects, not objects as such, only in the form of cross-reference and mapping data for each object in the power network.

The XLST transforms are a preferred adapter implementation for translating the XML based CIM model data into a format that can operated on local objects 2o, 3o, 4o which provide access and retrieval, read and write access, into the local SCADA, GIS and CMMS databases. This access is not necessarily identical and may well be different for different systems or databases. All participating applications must provide read and write access to their data sets through APIs (database access, OPC access, direct API access), where APIs are Application Programming Interfaces and OPC is an industry standard for linking or locating data called Object (Linking and Embedding) for Process Control.

The VAR 10 consists of the following components:
A global CIM/XML based data model for exchange of data between the involved applications (typically GIS, CMMS and SCADA)
A mechanism and means for Data Consistency. If an object is created or modified in one of the systems, the changes are reflected also in the other systems. This means that the object is automatically created or the attributes are changed in the other systems. The data consistency checking may be run as a real-time process or alternatively may be run as a batch job that is run once a day for example.
a database, preferably an SQL (Structured Query Language) database, for example an Oracle™ or MS SQL Server (Microsoft SQL server TM) that contains cross-reference/mapping tables for objects in the different applications and tables of object types that describe what attributes the objects have in each application. This is especially important when each application has its own names for the same objects and attributes. It should be noted that this database contains only cross-reference and mapping data: in this sense it is a virtual asset register (VAR) because it does not contain the actual object data as such. It contains only the cross-reference and mapping data and the actual data that describes each object is stored in each applications database, that is, in the SCADA system, the GIS system, the CMMS system and so on.

FIG. 13 shows the arrangement of FIG. 1 with the role of adapters, such as the adapters shown and described in relation to FIG. 12. The figure shows a possible inclusion of applications known as Message oriented Middleware (MoM). It also shows that other database systems Na may optionally be included in the computer-based system as well as SCADA, GIS, CMMS systems. For example other related and/or legacy systems such as CIS, PM, WMS, WOS.

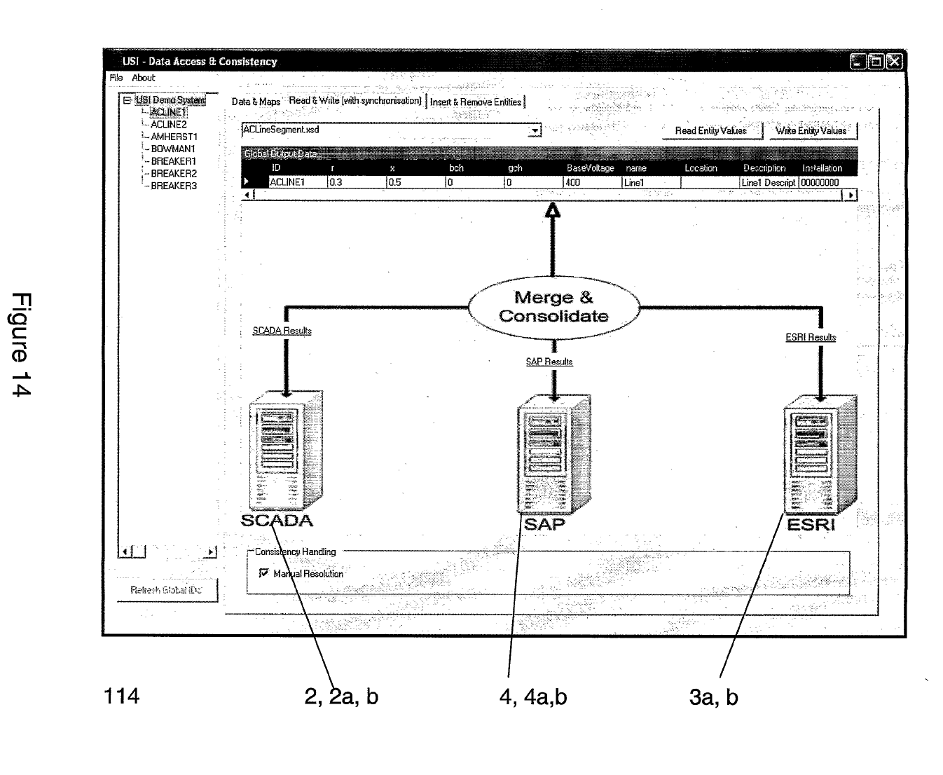

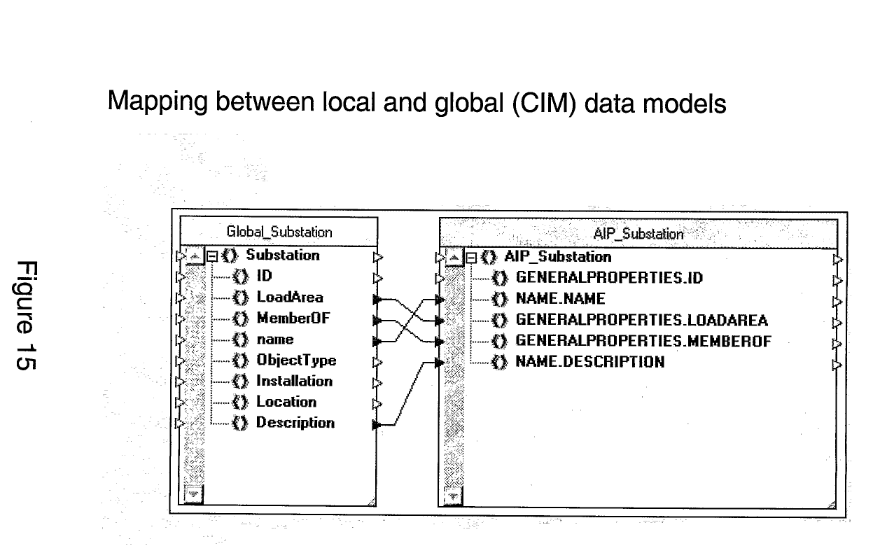

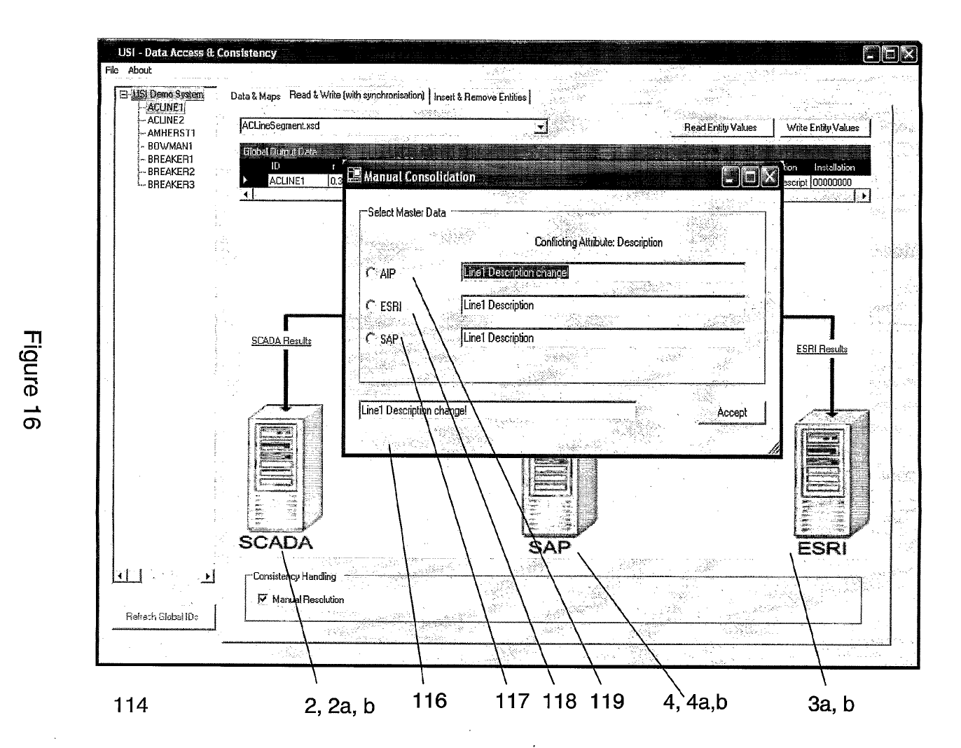

FIG. 14 shows a display and input member for consistency checking between the separate IT systems. It shows a SCADA system 2, SAP (CMMS) system 4, and an ESRI (GIS/NIS) system 3. (SAP is a trademark). FIG. 15 shows a schema for mapping between global objects and local objects which is part of the consistency checking functions described in relation to FIG. 14. It can be seen in this example that CIM-type Global substation objects LoadArea, MemberOF, name and Description are in this case mapped to the following local substation objects GENERALPROPERTIES.LOADAREA, GENERALPROPERTIES.MEMEBEROF, NAME.NAME and NAME.DESCRIPTION respectively. FIG. 16 shows conflict handling within the consistency functionality. Here it may be seen that one three IT systems, AIP 117, ESRI 118 and SAP 119 are available from a user or engineer to select as Master data or source data to resolve a potential consistency conflict.

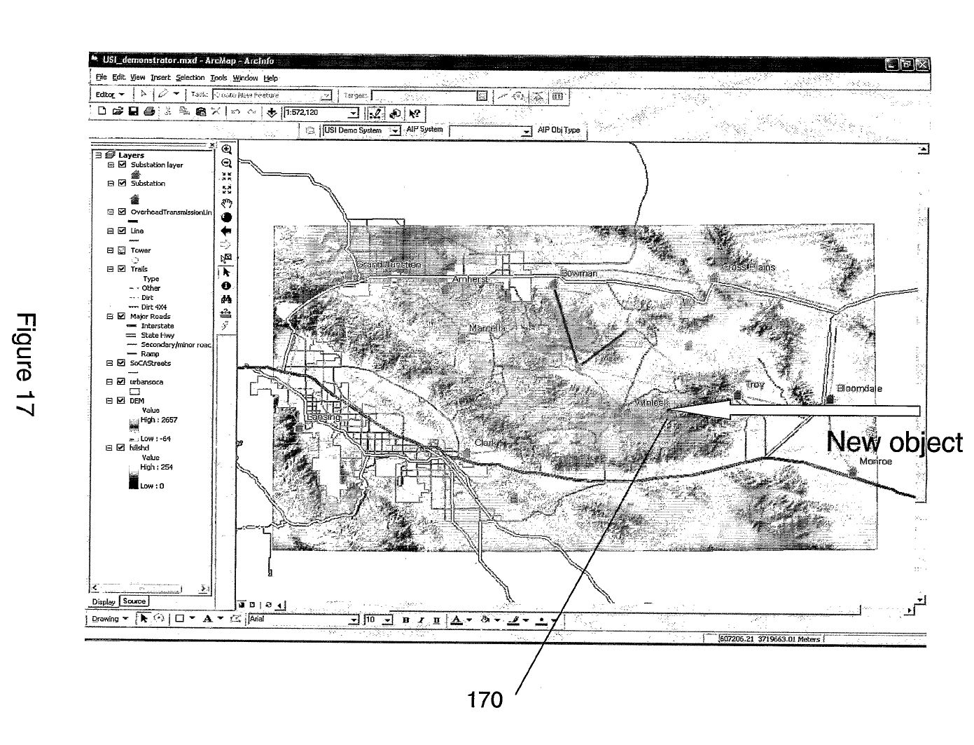

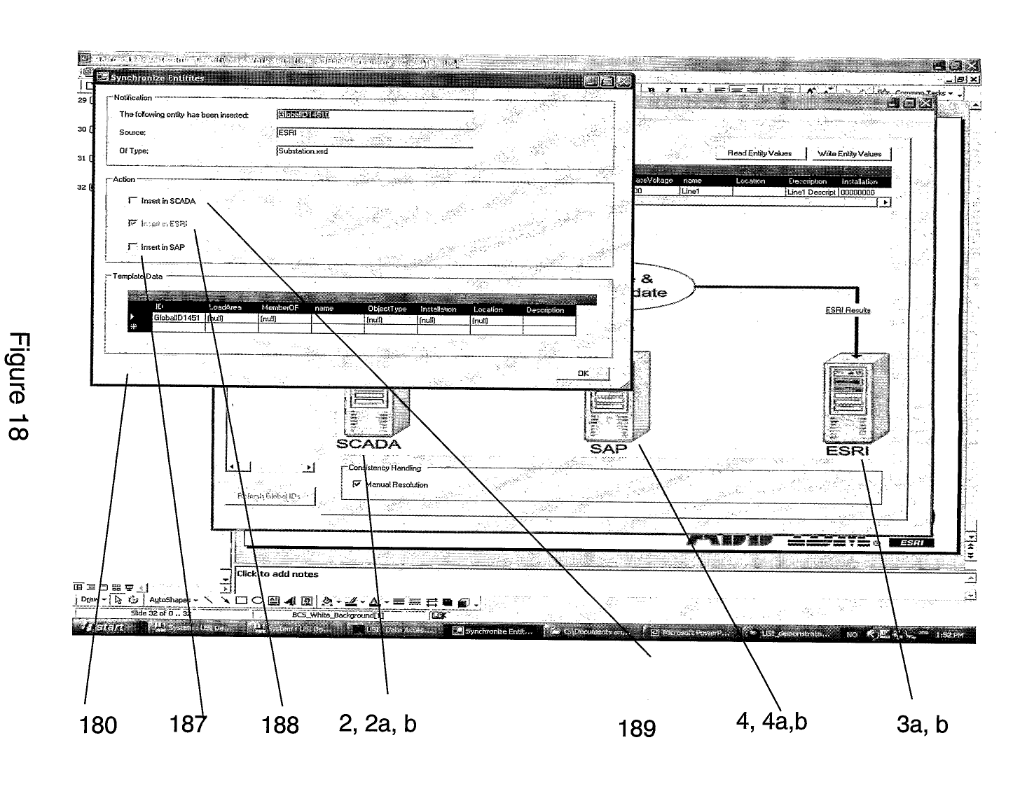

FIG. 17 shows the insertion of a new object 170 in a display from a GIS system. FIG. 18 shows a combination of the GIS and a synchronization window 180, which may be a part of the data consistency functions. It may be seen that the GIS system ESRI has flagged a new object substation.xsd, and options are presented to Insert in SCADA 189, or insert in SAP 187. The option to insert in ESRI 188 is grayed, as the object has already been detected as inserted in the GIS system ESRI.

The integration may be implemented by means of a SCADA system with a SCADA user interface, of the WS500 type of the Spider system for SCADA provided by ABB, and a CMMS maintenance management system from IFS, a NIS or GIS system such as ESRI planning & mapping system and a HMI integration platform and/or application integration platform such as an ABB Industrial IT system from ABB. The invention demonstrates a seamless user interface integration between SCADA, CMMS or GIS with context sensitive access to CMMS from SCADA or GIS (by means of object linking) in a computer-based system comprising access to those separate IT systems described.

The invention makes it possible to operate one or more parts of one or more power networks as one global or enterprise level data model of the assets (CIM+).

Attribute consistency—updating attribute values (overlapping)
Object consistency—adding/deleting objects:
Single data entry
One consistent enterprise level: Virtual Asset Register (VAR)
Add new object (in all relevant systems)
Object created in each system based on object templates
Connections between systems established automatically
Delete object (in all relevant systems)
Delete defined object in each system
Delete object connections (links)
Access object attributes (all)
Select object by identifier (any system)
Read out any object property independent of source
Modify object attribute(s)
Select object by identifier (any system)
Update attribute in source system (owner)
Replicate data to other systems (readers of the data)
Maintain object connections (links)

Power network equipment in an Energy Management System (EMS) or Distribution Management System (DMS) may include any combination or combinations of transmission lines, distribution lines, transformers or reactors of various types, switchyards, substations, protection devices, live tank circuit breaker, disconnector, switch-disconnector or load disconnector, earthing switch, disconnector circuit breaker, dead tank circuit breaker, gas-insulated circuit breaker, gas-insulated disconnector, earthing switch, switchgear modules including CBs, DCs, SDs etc as above.

CIM, Common Information Model, is an industry standard approach in the Energy Management System industry covering the use of XML formats in data exchange. More information on current practices and method for use of CIM/XML for data exchange within the electrical power industry may be obtained from North American Electricity Reliability Council (NERC), Federal Energy Regulatory Commission (FERC).

The CIM language includes a set of class diagrams that use the UML, Unified Modeling Language. CIM/XML may be described as the incorporation of elements from the RDF (Resource Description Framework, as defined by W3C) data model to form CIM/XML. For example by using an RDF element, a URI (Uniform Resource Identifier), to represent resources. Resources may correspond to objects and properties may correspond to object attributes.

An XML grammar, as defined in a suitable DTD (Document Type Definition) can be used both to represent CIM declarations (classes, instances and qualifiers) and CIM messages for use by the CIM mapping onto another protocol such as HTTP. Mapping with an XML derivative may be carried out using any suitable approach, such as schema mapping in which the XML Schema is used to describe the CIM classes, and CIM Instances are mapped to valid XML Documents for that schema; or meta-schema mapping in which the XML schema describes the CIM meta-schema, and both CIM classes and instances are valid XML documents for that schema.

Use of an XML or XML/CIM format may include the use of stylesheets and in particular XSLT stylesheets. A well-formed XML document may include both elements that are defined by XSLT and elements that are not defined by XSLT. XSLT stands for eXtensible Stylesheet Language Transform—thus it is a programming language, or other means, for transforming XML documents and rendering them in HTML or between different formats. XSLT-defined elements are distinguished by belonging to a specific XML namespace. A transformation expressed in XSLT is called a stylesheet. This is because, in the case when XSLT is transforming into the XSL formatting vocabulary, the transformation functions as a stylesheet.

Other current standards capable of use for data exchange include derived protocols such as COM (Component Object Model) Document Object Model (DOM), Microsoft's (Trade Mark) MSXML and a standard called XHTML 1.0 provided by World Wide Web Committee (W3C). The invention is not limited to XML based implementations and may alternatively use any derivative of a format such as the Standard Generalised Markup Language (SGML) meta-language, or Hyper Text Markup Language (HTML), extended Markup Language (XML) or derivatives such as XHTML 1.0, Extended Stylesheet Language (XSL) and the Document Object Model (DOM); or adaptions suited for user to handle using applications on portable or mobile devices, for example Wireless Markup Language (WML), which may be used with a WAP telephone may be described as a derivative of XML, or a WDML derivative, or WBXML.

The client applications of the HMI may be implemented as a thin client using a structured text document or file to present any of CIM/XML information, arguments, variables, addresses, links, mappable objects, executable applications or applets, or for example an HTML or other WWW based or HTML derivative protocol or XML protocol. The structured text document or file format takes care of handling graphical user display and activation functions of the HMI client. Activation functions refers to functions in the web page or web client display carried out by executable applications or applets which may be implemented as Java™ or similar. By means of such a thin client version of the HMI with an architecture such as that shown in FIG. 1, 2, 4, 19, a user or a technician may examine status or data, configure a parameter, change set points and/or issue commands remotely in to any object for which he/she has authority to so do via the navigation interface.

The methods of the invention may be carried out by means of one or more computer programs comprising computer program code or software portions running on a one or more servers, a computer, or a processor. The computer or microprocessor (or processors) comprises a central processing unit CPU performing the steps of the method according to one or more facets of the invention, such as the methods described. The methods are performed with the aid of one or more said computer programs, which are stored at least in part in memory accessible by the one or more processors.

For example a program or part-program that carries out some or all of the steps of methods such as that described in relation to FIG. 19, may be run by a computer or processor of the computer-based system. At least one of the servers or computers may be in a central object oriented control system in a local or distributed computerised control system. It is to be understood that said computer programs may also be run, at least in part, on one or more general purpose industrial microprocessors or computers instead of one or more specially adapted computers or processors.

The computer program comprises computer program code elements or software code portions that make the computer perform the method using equations, algorithms, data, stored values and calculations previously described. A part of the program may be stored in a processor as above, but also in a ROM, RAM, PROM, EPROM, or EEPROM chip or similar memory means. The program in part or in whole may also be stored on, or in, other suitable computer readable medium such as a magnetic disk, CD-ROM or DVD disk, hard disk, magneto-optical memory storage means, in volatile memory, in flash memory, as firmware, stored on a data server or on one or more arrays of data servers, or in high security data storage systems. Other known and suitable media, including removable memory media such as removable flash memories, hard drives etc. may also be used at least in respect of part of the data.

Data may also be communicated wirelessly between various parts of a power network, and/or to or from one or more of the different IT systems and databases. For example data may be collected from sensors arranged on equipment on a line or in a switchyard or a substation, stored and communicated as necessary by a SCADA system. Wireless communications may be carried out using any suitable protocol, including a wireless telephone system such as GSM or GPRS. Signals from a SCADA, CMMS or other system may also be sent via wireless communication to an equipment in a power network arranged with wireless communication so as for example as a result of an update of maintenance status, to activate a control, to set a breaker to maintenance mode, or perform a control action. Short range radio communication is a preferred technology, using a protocol compatible with, standards issued by the Bluetooth Special Interest Group (SIG), any variation of IEEE-802.11, WiFi, Ultra Wide Band (UWB), wireless personal area network (WPAN) such as ZigBee according to IEEE-802.15.4, IEEE-802.13 or equivalent or similar. In particular a radio technology working in, for example, the ISM band with significant interference suppression means by spread spectrum technology is advantageous, especially communication for field devices or sensors. For example a broad spectrum wireless protocol in which each or any data packet may be re-sent at other frequencies of a broad spectrum 7 times per millisecond, for example, may be used, such as in a protocol from ABB called Wireless interface for sensors and actuators (Wisa).

The computer programs described above may also be arranged in part as a distributed application capable of running on several different computers or computer systems at more or less the same time. Programs as well as data such as energy related information may each be made available for retrieval, delivery or, in the case of programs, execution over the Internet.

Data and/or methods may be accessed by software entities or other means of the control system by means of any of the lost of: OPC, OPC servers, an object request broker such as COM, DCOM or CORBA, a web service.

It is also noted that while the above describes exemplifying embodiments of the invention, there are several variations and modifications which may be made to the disclosed solution without departing from the scope of the present invention as defined in the appended claims.

1. A method for retrieving and accessing data stored in a plurality of systems arranged for operating part of one or more electrical power networks which method comprises adding a new object into a first system, characterised by subsequently adding a copy of the new object into a plurality of relevant systems, establishing automatically a connection between said relevant systems and the new object, and replicating data related to the new object to other systems and relevant systems.

2. A method according to claim 1, characterised by maintaining object connections (links) for the new object and for any other object accessed, retrieved and/or stored by a SCADA system as well as by any system from the list of: GIS system, ERP system, CMMS system, PM system, WO system, WMS system.

3. A method according to claim 2, characterised by establishing the consistency of accessed or retrieved data in the relevant systems by means of mapping the new object using a model based on a structured text document.

4. A method according to claim 3, characterised by checking the consistency of attributes of the accessed or retrieved data by identifying the new or a given object and/or copies of the new or a given object and comparing attributes of all copies of the same new or given object.

5. A method according to claim 4, characterised by mapping the new object and/or copies of the new object using a model based on a CIM/XML document.

6. A method according to claim 4, characterised by mapping attributes of the new object and/or copies of the new object using a model based on a CIM/XML document.

7. A method according to claim 1, characterised by establishing the automatic connection or connections between copies of the same object in different systems means of a CIM/XML layer (1).

8. A method according to claim 1, characterised by mapping the new object by means of a virtual asset register (10) dependent on the CIM/XML layer (1) and/or mapping.

9. A method according to claim 1, characterised by selecting an object by means of an identifier in any said relevant system.

10. A method according to claim 9, characterised in that the identifier may be a URI (Uniform Resource Identifier) compatible as an identifier with a standard for RDF (Resource Description Framework).

11. A method according to claim 6, characterised by accessing one or more object attributes of the new object and changing an object attribute of the new object in a source system (owner, the first system).

12. A method according to claim 6, characterised by updating an object attribute of the new object in the source system (owner, the first system).

13. A method according to claim 1, characterised by creating the new object in each relevant system based on object templates.

14. A method according to claim 1, characterised by deleting an object by deleting the object in all relevant systems.

15. A method according to claim 14, characterised by deleting an object by deleting a defined object in each system.

16. A method according to claim 15, characterised by deleting an object by deleting object connections (links) to a deleted object or deleted defined object.

17. A computer program for retrieving and accessing data stored in a plurality of systems arranged for operating part of one or more electrical power networks comprising software code portions or computer code to cause a computer or processor to carry out the steps of a method according any of claims 1-16.

18. A computer program product recorded on a computer readable medium which when read into a computer or processor will cause the computer or processor to carry out a method according to any of the steps of claims 1-16.

19. An asset register for retrieving and accessing data stored in a plurality of systems arranged for operating part of one or more electrical power networks, characterised in that said asset register comprises a list of power network assets which list comprises in turn cross reference and mapping data for objects represented and/or stored in a SCADA system as well as in any system from the list of: GIS system, ERP system, CMMS system.

20. An asset register according to claim 19, characterised by a comprising a list of references for all objects representing individual items of physical and/or logical equipment comprised in the one or more parts of the said power network.

21. An asset register according to claim 20, characterised in that the list comprises a master list of all objects in the one or more parts of the said power network together with the mapping data for each object according to a CIM model.

22. An asset register according to claim 21, characterised in that object data for the objects comprised in the master list of the asset register is stored in at least one separate system including any of a system for: SCADA, GIS, CMMS, ERP, PM, WO.

23. An asset register according to claim 21, characterised in that the asset register is a virtual asset register which does not comprise any object data for the objects comprised in the master list and comprises only link information or cross reference data or mapping data.

24. A human-machine interface for retrieving and accessing data stored in a plurality of systems arranged for operating part of one or more electrical power networks, which HMI comprises a display including data accessed or retrieved from or stored in a SCADA system, characterised by also comprising data accessed or retrieved from or stored in any from the list of: GIS system, ERP system, CMMS system, PM system, WO system.

25. A human-machine interface according to claim 24, characterised by at least one graphical user interface with means for manipulation of the data retrieved from or stored in the SCADA and any of the systems for GIS and/or ERP and/or CMMS.

26. A human-machine interface according to claim 24, characterised by reading out any object property independent of source.

27. A human-machine interface according to claims 24-26, characterised by means to provide access to simultaneous data stored in or held by any of the list of: SCADA system, GIS system, ERP system, CMMS system, PM system, WO system.

28. A computer-based system for retrieving and accessing data stored in a plurality of systems arranged for operating part of one or more electrical power networks, characterised in that said computer-based system comprises a plurality of databases and a data communication network and which system includes an HMI providing navigation and access to at least one SCADA system and/or database as well as to any system and/or database from the list of: ERP, GIS, CMMS, WO, WMS, PM.

29. A computer-based system according to claim 28, characterised by comprising one or members for: adding a new object; automatically establishing a connection between said relevant systems and the new object; and for replicating data related to the new object to other systems and relevant systems.

30. A computer-based system according to claim 29, characterised by comprising one or members for: maintaining object connections; providing connection or connections by means of a layer with a structured text document protocol; and mapping the new object by means of a structured text document model.

31. A computer-based system according to claim 30, characterised in that any of: the structured text document protocol layer, or the structured text document means for mapping the new object are implemented with a CIM/XML model.

32. A computer-based system according to claim 28, characterised by comprising one or members for checking the consistency of attributes of any data so accessed or retrieved data by identifying the or each new or given object and/or copies of the new or given object in any separate system, and comparing attributes of all such copies of the same new or given object from each of the separate systems.

33. A computer-based system according to claim 28, characterised by a virtual asset register.

34. A computer-based system according to claim 28, characterised by a virtual asset register implemented according to an XML or CIM model or document.

35. A computer-based system according to claim 28, characterised by an HMI that may comprise object data accessed or retrieved or stored in a SCADA system and/or database as well object data originating in any system and/or database from the list of: ERP, GIS, CMMS, WO, PM.
